(19) United States
(12) Patent Application Publication
(10) Pub. No.: US 2025/0223011 A1
(43) Pub. Date: Jul. 10, 2025

(54) ASSEMBLY AND METHOD FOR LOWERING MONOPILES FROM A FLOATING VESSEL

(71) Applicant: Heerema Marine Contractors Nederland SE, Leiden (NL)

(72) Inventors: Sieds Anne JENSMA, Leiden (NL); Alessio PISTIDDA, Leiden (NL); Ivan VAN WINSEN, Leiden (NL); Jelle Christian TER BRAAK, Leiden (NL); Gerardus Petrus MESKERS, Leiden (NL)

(21) Appl. No.: 18/852,832

(22) PCT Filed: Mar. 31, 2023
(86) PCT No.: PCT/EP2023/058554

§ 371 Date: Sep. 30, 2024

Related U.S. Application Data
(60) Provisional application No. 63/326,271, filed on Mar. 31, 2022.

(30) Foreign Application Priority Data
Aug. 29, 2022 (NL) 2032881

(51) Int. Cl. B63B 27/16; B63B 27/30; B66C 23/18; B66C 23/52

(52) U.S. Cl. CPC B63B 27/16; B63B 27/30; B66C 23/185; B66C 23/52

(57) ABSTRACT

The present invention relates to an assembly for lowering a pile onto a seabed, the assembly comprising: —a floating vessel (24) comprising a vessel positioning system (42), —a crane (12) provided on the vessel for lowering the pile (10) onto the seabed, —a pile guiding system (50) configured to guide the pile during the lowering thereof by the crane, the pile guiding system comprising: —o a base (40) connected to the vessel, o at least one pile guiding frame (20) comprising an annular portion (21), o one or more primary actuators (55) which are configured for moving the pile guiding frame, o one or more secondary actuators (60) connected to the annular portion of the pile guiding frame, o at least one frame position sensor (62) for measuring an excitation parameter, o a guiding control unit (64) comprising an excitation controller (80) configured to control the actuators and a resilience controller configured to control a stiffness.

### FIELD OF THE INVENTION

The present invention relates to an assembly and a method for lowering a pile onto and partially into a seabed from a floating vessel in an offshore environment. The pile forms the foundation of a wind turbine generator (WTG). The pile is also referred to as a monopile.

### BACKGROUND OF THE INVENTION

Offshore wind energy is gaining importance and a substantial number of offshore wind farms are being planned. Several of these windfarms are being planned in relatively deep waters. At the same time, the technology of wind turbine generators progresses. One aspect of this technological development is that wind turbine generators gradually become larger. These developments result in significant challenges for the installation of WTGs at sea.

One of the challenges is the installation of the monopile. The monopile is the lower section of the mast. The monopile should be lowered onto the seabed in a vertical orientation. The monopile subsequently penetrates the seabed over a certain depth under its own weight. Next, the monopile is typically hammered into the seabed to a deeper level. Other methods of connecting the monopile to the seabed than hammering also exist.

This operation may be carried out from a floating installation vessel having a crane which lowers the monopile to and into the seabed. In order to further control the movements of the monopile during the lowering, a so-called pile guiding frame is typically provided. Such pile guiding frames are used from jack-up rigs which stand on their legs and are stationary during the installation process. The pile guiding frame typically extends outwardly over a horizontal direction from the hull of the vessel. The monopile is accommodated in a through-passage in the pile guiding frame. The pile guiding frame can exert horizontal forces on the monopile and limits lateral motions of the monopile with respect to earth and with respect to the stationary jack-up rig.

In the present invention, it was recognised that with this configuration, a variety of problems may occur. One problem is that the configuration may become unstable once the monopile touches the seabed. If the floating vessel moves away from a target position, the monopile may start to tilt. As a result, the resulting horizontal force on the pile guiding frame may become so great that the dynamic positioning system (DP system) of the vessel cannot maintain the position of the vessel, resulting in a further movement of the vessel and further tilting of the monopile.

Another potential problem is that the force between the pile and the pile guiding frame may become so great that damage to the equipment including the monopile may occur.

Also, the verticality of the monopile may become affected as a result of errors in setpoints, errors in measurements of the vessel location. This could potentially result in a monopile that is installed in an inclined orientation wherein the inclination lies outside an acceptable tolerance.

WO2021148479A2 discloses an assembly and method for installing a pile into the seabed. The assembly comprises a vessel with an positioning system, a pile guiding system with at least one pile guiding device and a resilient member. The pile guiding system may comprise a first and a second pile guiding device, wherein the second pile guiding device is positioned vertically below the first pile guiding device. The resilient member provides an resilient connection between the pile and the vessel. The stiffness of the resilient member may be adjusted by a separate adjusting member and will decrease when the pile penetrates into the seabed. The connection stiffness has to be low enough to keep the natural period of a pivoting movement of the pile about the seabed longer than the dominant wave period.

In the present invention, it was found that an excessive drift of the vessel can be the result of a low stiffness between the pile and the vessel. An excessive drift off could potentially result in a situation wherein the one or more primary actuators runs out of actuator stroke.

The following documents also disclose gripper frames and are identified as relevant background literature: CN207003439U, WO2021245175A1, WO2021245236A1, U.S. Pat. No. 20,203,08796A1, EP3517479A1, WO2021058544A1 and U.S. Pat. No. 20,203,47960A1.

### OBJECT OF THE INVENTION

It is an object of the present invention to improve the process of installing a monopile from a floating vessel.

It is a further object of the present invention to reduce the forces between the monopile and the floating vessel during the installation of the monopile.

It is a further object of the present invention to prevent instability of the combination of installation vessel and monopile during the installation of the monopile.

It is a further object of the present invention to obtain a better control of the verticality of the monopile during the installation of the monopile from a floating installation vessel.

### SUMMARY OF THE INVENTION

In order to achieve at least one object, the invention provides an assembly for lowering a pile onto and partially into a seabed, the assembly comprising:
a floating vessel comprising a vessel positioning system, in particular a DP system, for maintaining the floating vessel at a vessel target location,
a crane provided on the vessel for lowering the pile onto and partially into the seabed, the crane comprising a lift member configured to be connected to the pile,
a pile guiding system configured to guide the pile during the lowering thereof by the crane, the pile guiding system comprising:
   a base connected to the vessel,
   at least one pile guiding frame comprising an annular portion, the pile guiding frame connected to the base via at least one primary actuator, the an annular portion of the pile guiding frame defining a through passage through which in use the pile extends, the pile guiding frame being configured to guide the pile during the lowering thereof, the pile guiding frame being configured to transfer a force (F) to the pile, wherein the force has a horizontal component,
   one or more primary actuators which are configured for moving the pile guiding frame relative to the base, wherein the one or more primary actuators are configured for providing said force,
   one or more secondary actuators connected to the annular portion of the pile guiding frame and extending at least partially inward from the annular portion, the one more secondary actuators being configured for maintaining the pile in a pile target position within the annular portion,
   at least one frame position sensor for measuring an excitation parameter indicative of an excitation of the pile guiding frame relative to a pile guiding frame target position, and
   a guiding control unit comprising an excitation controller configured to control the one or more primary actuators in dependence of the measured excitation of the pile guiding frame relative to the pile guiding frame target position in order to move the pile guiding frame to the pile guiding frame target position in case of an excitation of the pile guiding frame,
      wherein the guiding control unit further comprises a resilience controller configured to control a stiffness of the one or more primary actuators and/or the one or more secondary actuators during the lowering of the pile into the seabed in order to limit the force between the pile and the vessel which is transferred via the pile guiding frame.

With the invention, instability of the system can be avoided. The floating vessel can be maintained within an acceptable range from the target position. The forces on the pile and the pile guiding frame can be maintained low enough to prevent damage. With the resilience controller the stiffness of the one or more primary actuators and/or the one or more secondary actuators can be varied during the lowering of the pile into the seabed. In this way, a risk of instability of the system can be mitigated. The stiffness may be associated with the proportional gain of the excitation controller and is expressed in N/m. If the secondary actuators are controlled

The words “increase the stiffness of the one or more primary actuators and/or the one or more secondary actuators” mean that the resilience controller changes the settings of the excitation controller, which in turn controls the one or more primary actuators and/or the one or more secondary actuators. In this way the stiffness of the one or more primary actuators and/or the one or more secondary actuators can be changed, and in particular increased.

In some embodiments, the resilience controller is configured to increase a stiffness of the one or more primary actuators and/or the one or more secondary actuators during the lowering of the pile into the seabed. In some embodiments, the resilience can be controlled to create a “softer” response from the one or more primary actuators and/or the one or more secondary actuators. This softer response ensures stability of the system while allowing some more error on the pile verticality. After the pile has penetrated into the seabed and the load on the crane tip has decreased because a part of the weight of the pile is carried by the seabed, the resilience controller can control the resilience to a stiffer setting because the risk of instability has decreased and a stiffer setting will not result in an instable system any longer. The general idea is that the resilience controller sets the resilience at a relatively soft setting as long as a large portion of the weight of the pile and the lift member is carried by the crane and sets the resilience to a stiffer setting when the portion of the weight of the pile and the lift member which is carried by the crane has reduced because the seabed carries a larger portion. With the present invention, an excessive drift of the vessel can be avoided, thereby also avoiding a situation wherein the one or more primary actuators runs out of actuator stroke. The stiffness may be associated with the proportional gain (P) of the excitation controller and this proportional gain is increased during the lowering. This can be done gradually or stepwise or with a combination of gradual and stepwise increases.

In some embodiments, the resilience controller is configured to control the stiffness of the one or more primary actuators and/or the one or more secondary actuators by:
a) adjusting a proportional gain (P) of the excitation controller,
   and/or
b) adjusting an integral gain (I) of the excitation controller and/or,
c) adjusting a derivative gain (D) of the excitation controller.

By adjusting these parameters of the excitation controller, the stiffness can be controlled, and in particular increased.

In some embodiments, the resilience controller is configured to limit the stiffness by:
a) outputting a speed to the one or more primary actuators and/or the one or more secondary actuators by the excitation controller and limiting said speed to a maximum speed,
   and/or
b) outputting a power to the one or more primary actuators and/or the one or more secondary actuators by the excitation controller and limiting said power to a maximum power,
   and/or
c) outputting a force to the one or more primary actuators and/or the one or more secondary actuators by the excitation controller and limiting said force to a maximum force.

The excitation controller has the excitation of the pile guiding frame as an input. The output can be a number of parameters, in particular speed, power and force. Each of these can be used to control the primary and/or secondary actuators.

In some embodiments, the resilience controller controls the stiffness of the primary and/or secondary actuator in order to maintain the force exerted by the pile on the vessel below a predetermined maximum vessel position force which can be delivered by the vessel positioning system. This effectively prevents instability. Generally, the pile guiding frame can move relative to the base over a finite stroke length in both X and Y direction. The force can be maintained below the predetermined maximum vessel force as long as the pile guiding frame does not reach the end of the stroke length.

If the secondary actuators are hydraulic actuators, they can be passively controlled by simply setting the stiffness of the hydraulic actuators to a certain value. For example by connecting or disconnecting nitrogen accumulators to the hydraulic actuator. In this way the stiffness of the secondary actuators can be controlled in a simple manner and the secondary actuators become springs. The accumulator specifics can be changed during the lowering of the pile which changes the spring constant. This can be done gradually or stepwise or with a combination of gradual and stepwise increases.

In some embodiments, the vessel positioning system comprises:
at least one vessel location sensor for measuring the location of the floating vessel relative to the vessel target location,
at least one thruster and/or at least one anchor winch configured for exerting a vessel position force,
a vessel position control unit configured for controlling the vessel position force in dependence of the measured vessel location for maintaining the floating vessel at the vessel target location,
   wherein the vessel positioning system is coupled to the guiding control unit, wherein the guiding control unit is configured:
a) to communicate the force exerted by the at least one primary actuator and/or secondary actuator to the vessel positioning system, wherein the vessel positioning system is configured to at least partially add the force to the vessel position force, and/or
b) to communicate the measured excitation of the pile guiding frame to the vessel positioning system, wherein the vessel positioning system is configured to convert the measured excitation into an additional force and at least partially add this additional force to the vessel position force,
   in order to maintain the floating vessel at the vessel target location while simultaneously exerting the force onto the pile. The force and/or the excitation is fed as a feed forward signal to the vessel positioning system, with the advantage that the position keeping capacity of the DP system is not disadvantageously affected by the forces from the pile on the vessel.

In some embodiments, the guiding control unit controls the one or more primary actuators in dependence of characteristics of the vessel positioning system, in particular in dependence of a maximum rate of change of the vessel position force which the vessel positioning system can deliver, in order to allow the vessel position force exerted by the vessel positioning system to follow or substantially follow variations in the force exerted by the primary actuator. The DP system of the vessel has a limited ramp-up capacity, meaning that the force cannot instantly be changed but needs some ramp-up time. When the one or more primary actuators are controlled to respond with the same rate of change or slower as the ramp-up characteristic of the DP system, vessel drift is reduced and pile verticality is improved.

In some embodiments, the pile guiding frame target position is a point on earth, and wherein the guiding control unit is configured to control the primary actuator and/or secondary actuator independently from the location of the floating vessel, or

wherein the position of the floating vessel is measured with regard to a vessel target location on earth, and wherein the guiding control unit is configured to control the primary actuator to cause the pile guiding frame to make an opposite movement as the movement of the floating vessel and/or to cause the secondary actuators to make an opposite movement as the movement of the vessel. This allows the force between the pile and the vessel to be controlled independently of the movement of the vessel.

In some embodiments, the resilience control unit is configured to receive a lift force parameter representative of a lift force exerted by the crane on the pile, wherein the resilience control unit is configured to increase the resilience of the one or more primary actuators and/or the one or more secondary actuators when the lift force decreases. This allows effective and possible automatic control of the resilience, and in particular allows automatic stiffening of the response when the pile is lowered into the seabed.

In some embodiments, the guiding control unit is configured to operate in:
a) an active control mode in which at least the integral gain (I) of the one or more primary actuators and/or the one or more secondary actuators is set to a value above zero, wherein in the active control mode the guiding control unit maintains the pile guiding frame target position at a constant value, and
b) a proportional-control-mode in which the proportional gain of the at least one primary and/or secondary actuator is set to a certain value and the integral gain (I) of the primary and secondary actuator(s) is set to zero,
   wherein the guiding control unit is configured to carry out an initial phase of the lowering process in the proportional-control-mode and to subsequently switch from the proportional-control-mode to the active control mode during the lowering of the pile.

In some embodiments, there may be an additional, different control prior to landing the pile on the seabed. This is called damping control mode. In the damping control mode, there is only an active derivative term in the PID controller. The proportional gain and the integrating term may be set to zero. When the pile lands on the seabed, the guiding control unit is switched from the damping control mode to the no-active-control-mode.

In some embodiments, the guiding control unit comprises an input for a lift force exerted by the crane, and wherein the guiding control unit is configured to switch from the proportional-control-mode to the active control mode when a lift force exerted by the crane drops below an active control threshold lift force which may be a percentage of an initial lift force exerted by the crane on the pile before the pile touches the seabed. This allows automatic avoidance of instability.

In some embodiments, the pile guiding system comprises a pile inclination input for input of an inclination angle of the pile relative to the vertical, wherein the control unit comprises an inclination mode, wherein the guiding control unit is configured to—in the inclination mode—adjust the pile guiding frame target position in dependence of the pile inclination input. The inclination mode allows control of the verticality of the pile. This control is not present in the active control mode. In the inclination control mode, the active control mode remains active.

In some embodiments, the guiding control unit comprises an outer feedback loop and an inner feedback loop, wherein the inner feedback loop is configured to control the at least one primary actuator and/or secondary actuator in dependence of the measured excitation of the pile guiding frame, and wherein the outer feedback loop is associated with the inclination mode and is configured to—in the inclination mode—determine an updated pile guiding frame target position based on the pile inclination input and to provide the inner feedback loop with the updated pile guiding frame target position. This was found to be a robust control system with which instability can be avoided and verticality can be ensured.

In some embodiments, the pile guiding system is configured to activate the inclination mode when the lift force drops below a predetermined inclination control threshold lift force which may be a percentage of an initial lift force exerted by the crane on the pile before the pile touches the seabed. In the inclination control mode the active control mode remains active. In the active control mode, only the inner loop is active. In the inclination control mode, both the inner loop and the outer loop are active.

In some embodiments, the inclination control threshold lift force (which may also be referred to as outer loop control threshold lift force) is in particular less than or equal to 90 percent of an initial lift force which is exerted by the crane before the pile touches the seabed and in particular less than or equal to 50 percent. In this way instability and excessive forces can be avoided during the first part of the lowering of the pile into the seabed.

In some embodiments, the pile guiding system comprises a pile inclination sensor for measuring the inclination angle of the pile, the pile inclination sensor being connected to the pile inclination input.

In some embodiments, the at least one primary actuator is a hydraulic actuator such as a hydromotor, or hydraulic cylinder, a pneumatic actuator, and/or an electric drive.

In some embodiments, the pile guiding system comprises at least one first primary actuator for moving the pile guiding frame in a first direction relative to the vessel, and at least one second primary actuator for moving the pile guiding frame in a second direction relative to the vessel, the second direction being substantially perpendicular to the first direction. Advantageously, the pile guiding frame can be moved in the horizontal X- and Y-direction.

In some embodiments, the pile guiding system and the pile guiding frame thereof is configured to exert only forces onto the pile and is configured to not exert any bending moment onto the pile.

In some embodiments, the pile guiding system further comprises at least one damping member for providing a damping connection between the pile and the floating vessel. Motions resulting from forces from waves and wind can be dampened in this way.

In some embodiments, the pile guiding frame in particular comprises one or more doors configured to move between an open position and a closed position, wherein the open position allows a pile to be laterally introduced in the through passage.

In some embodiments, the pile guiding frame extends outboard of the hull and extends over a horizontal distance away from a hull of the vessel.

In some embodiments, the positioning system is a dynamic positioning system comprising a plurality of azimuth thrusters.

In some embodiments, the assembly comprises at least one pile position sensor for measuring an excitation of the pile relative to a pile target position with respect to the annular portion of the pile guiding frame, wherein the pile target position is in particular a central position within the annular portion of the pile guiding frame, and the guiding control unit is configured to control the one or more secondary actuators in dependence of the measured excitation in order to move the pile to the pile target position, and in particular to move the pile to a central position within the annular portion of the pile guiding frame.

The present invention also relates to a method for lowering a pile onto and at least partially into a seabed with a floating vessel, the method comprising the steps:
a) positioning the floating vessel of the assembly according to any of the preceding claims at a vessel target location,
b) connecting the pile to the lift member and holding the pile in an upright or generally upright orientation in the pile guiding frame of the pile guiding system,
c) lowering the pile to the seabed with the crane and the lift member,
d) touching down the pile on the seabed at the pile target location with the crane and the lift member,
e) lowering the pile down into the seabed with the crane and the lift member wherein at least during step e) the guiding control unit controls the one or more primary actuators in dependence of the measured excitation of the pile guiding frame relative to the pile guiding frame target position to move the pile guiding frame to the pile guiding frame target position in case of an excitation of the pile guiding frame, and/or to control the one or more secondary actuators in dependence of the measured excitation of the pile guiding frame relative to the pile guiding frame target position in order to move the pile opposite to the movement of the pile guiding frame,

wherein the guiding control unit further comprises a resilience controller which controls a stiffness of the one or more primary actuators and/or the one or more secondary actuators during the lowering of the pile into the seabed in order to limit the force between the pile and the vessel.

The method has substantially the same advantages as the assembly according to the invention.

In some embodiments of the method, the resilience controller increases a stiffness of the one or more primary actuators and/or the one or more secondary actuators during the lowering of the pile into the seabed.

In some embodiments, the resilience controller controls the stiffness of the one or more primary actuators and/or the one or more secondary actuators by:
a) adjusting a proportional gain (P) of the excitation controller, and/or
b) adjusting an integral gain (I) of the excitation controller and/or,
c) adjusting a derivative gain (D) of the excitation controller.

In some embodiments, the guiding control limits the resilience by:
a) outputting a speed to the one or more primary actuators and/or the one or more secondary actuators by the excitation controller and limiting said speed to a maximum speed, and/or
b) outputting a power to the one or more primary actuators and/or the one or more secondary actuators by the excitation controller and limiting said power to a maximum power, and/or
c) outputting a force to the one or more primary actuators and/or the one or more secondary actuators by the excitation controller and limiting said force to a maximum force.

In some embodiments of the method, the vessel positioning system comprises:
at least one vessel location sensor for measuring the location of the floating vessel relative to the vessel target location,
at least one thruster and/or at least one anchor winch configured for exerting a vessel position force,
a vessel position control unit configured for controlling the vessel position force in dependence of the measured vessel location for maintaining the floating vessel at the vessel target location,
   wherein the vessel positioning system is coupled to the guiding control unit, wherein the guiding control unit:
a) communicates the force exerted by the at least one primary actuator and/or secondary actuator to the vessel positioning system, wherein the vessel positioning system at least partially adds the force to the vessel position force to the vessel position force, and/or
b) communicates the measured excitation of the pile guiding frame to the vessel positioning system, wherein the vessel positioning system converts the measured excitation into an additional force and at least partially adds this additional force to the vessel position force, in order to maintain the floating vessel at the vessel target location while simultaneously exerting the force onto the pile.

In some embodiments of the method, the guiding control unit controls the primary actuator and/or secondary actuators in dependence of characteristics of the vessel positioning system, in particular in dependence of a maximum rate of change of the vessel position force which the vessel positioning system can deliver, in order to allow the vessel position force exerted by the vessel positioning system to follow or substantially follow variations in the force exerted by the primary actuator.

In some embodiments of the method, the resilience control unit receives a lift force parameter representative of a lift force exerted by the crane on the pile, wherein the resilience control unit increases the resilience of the one or more primary actuators and/or the one or more secondary actuators when the lift force decreases.

In some embodiments of the method, the guiding control unit comprises an active control mode in which the one or more primary actuators and the one or more secondary actuators are actively controlled, wherein in the active control mode the guiding control unit maintains the pile guiding frame target position at a constant value.

In some embodiments of the method, the pile guiding system comprises a pile inclination input for input of an inclination angle of the pile relative to the vertical, wherein the control unit comprises an inclination mode, wherein in the inclination mode the guiding control unit adjusts the pile guiding frame target position in dependence of the pile inclination input.

In some embodiments of the method, the guiding control unit comprises an outer feedback loop and an inner feedback loop, wherein the inner feedback loop controls the at least one primary actuator and/or secondary actuator in dependence of the measured excitation of the pile guiding frame, and wherein the outer feedback loop is associated with the inclination mode and—in the inclination mode—determines an updated pile guiding frame target position based on the measured pile inclination provides the inner feedback loop with the updated pile guiding frame target position.

In some embodiments of the method, the pile guiding system activates the inclination control mode when the lift force drops below a predetermined inclination control threshold lift force which may be a percentage of an initial lift force exerted by the crane on the pile before the pile touches the seabed.

In some embodiments of the method, the predetermined inclination control threshold lift force is lower than the active control threshold lift force.

In some embodiments of the method, the pile guiding frame exerts a force on the pile in an X-direction and in a Y-direction and the pile slides or rolls relative to the pile guiding frame in a Z-direction.

In some embodiments of the method, the pile guiding system dampens pivoting motions of the pile about the seabed with a damping member which provides a damping connection between the floating vessel and the pile.

The present invention further relates to a pile guiding system configured to guide a pile during the lowering thereof by a crane of a floating vessel, the pile guiding system comprising:
a base configured to be connected to the vessel,
at least one pile guiding frame comprising an annular portion, the pile guiding frame connected to the base via at least one primary actuator, the annular portion of the pile guiding frame defining a through passage through which in use the pile extends, the pile guiding frame being configured to guide the pile during the lowering thereof, the pile guiding frame being configured to transfer a force (F) to the pile, wherein the force has a horizontal component,
one or more primary actuators which are configured for moving the pile guiding frame relative to the base, wherein the one or more primary actuators are configured for providing said force (F),
one or more secondary actuators connected to the annular portion of the pile guiding frame and extending at least partially inward from the annular portion, the one more secondary actuators being configured for maintaining the pile in a pile target position within the annular portion,
at least one frame position sensor for measuring an excitation parameter indicative of an excitation of the pile guiding frame relative to a pile guiding frame target position, and
a guiding control unit comprising an excitation controller configured to control the one or more primary actuators in dependence of the measured excitation of the pile guiding frame relative to the pile guiding frame target position in order to move the pile guiding frame to the pile guiding frame target position in case of an excitation of the pile guiding frame, and/or to control the one or more secondary actuators in dependence of the measured excitation of the pile guiding frame relative to the pile guiding frame target position in order to move the pile opposite to the movement of the pile guiding frame,
   wherein the guiding control unit further comprises a resilience controller configured to control a stiffness of the one or more primary actuators and/or of the one or more secondary actuators during the lowering of the pile into the seabed in order to limit the force between the pile and the vessel which is transferred via the pile guiding frame.

The pile guiding system has the same advantages as the assembly according to the present invention.

In some embodiments, the resilience controller is configured to increase a stiffness of the one or more primary actuators and/or the one or more secondary actuators during the lowering of the pile into the seabed.

In some embodiments, the resilience controller is configured to control the stiffness of the one or more primary actuators and/or the one or more secondary actuators by:
a) adjusting a proportional gain (P) of the excitation controller, and/or
b) adjusting an integral gain (I) of the excitation controller and/or,
c) adjusting a derivative gain (D) of the excitation controller.

In some embodiments, the resilience controller is configured to limit the stiffness by:
a) outputting a speed to the one or more primary actuators and/or the one or more secondary actuators by the excitation controller and limiting said speed to a maximum speed, and/or
b) outputting a power to the one or more primary actuators and/or the one or more secondary actuators by the excitation controller and limiting said power to a maximum power, and/or
c) outputting a force to the one or more primary actuators and/or the one or more secondary actuators by the excitation controller and limiting said force to a maximum force.

In some embodiments of the pile guiding system, the pile guiding system comprises a pile inclination input for input of an inclination angle of the pile relative to the vertical, wherein the control unit comprises an inclination mode, wherein in the inclination mode the guiding control unit is configured to adjust the pile guiding frame target position in dependence of the pile inclination input.

In some embodiments of the pile guiding system, the guiding control unit comprises an outer feedback loop and an inner feedback loop, wherein the inner feedback loop is configured to control the at least one primary actuator and/or secondary actuator in dependence of the measured excitation of the pile guiding frame, and wherein the outer feedback loop is associated with an inclination mode and is configured to—in the inclination mode—determine an updated pile guiding frame target position based on the measured pile inclination and to provide the inner feedback loop with the updated pile guiding frame target position.

In some embodiments, the pile guiding system comprises at least one pile position sensor for measuring an excitation of the pile relative to a pile target position within the pile guiding frame, and the pile guiding frame is configured to control the one or more secondary actuators in dependence of the measured excitation of the pile relative to the pile target position to move the pile to the pile target position in case of an excitation of the pile relative to the pile target position.

In a different aspect, an assembly is provided for installing a pile at least partially into a seabed, the assembly comprising:
a floating vessel comprising a vessel positioning system for keeping the vessel at a vessel target location, wherein the vessel positioning system comprises:
   at least one vessel location sensor for measuring the location of the floating vessel relative to the vessel target location,
   at least one thruster and/or at least one anchor winch configured for exerting a vessel position force,
   a vessel position control unit configured for controlling the vessel position force in dependence of the measured vessel location for maintaining the floating vessel at the vessel target location,
a pile guiding system configured to guide the pile during the installation thereof, the pile guiding system comprising:
   a base provided on the vessel,
   a pile guiding frame connected to the base, the pile guiding frame being configured to accommodate and guide the pile during the installation thereof, wherein the pile guiding frame is configured to exert a force (F) on the pile, wherein the force has a horizontal component,
   a first sensor configured to measure a parameter indicative of a force of the pile guiding frame exerted on the pile, the first sensor being in communication with the vessel position control unit of the vessel positioning system,
      wherein the vessel positioning system is configured to at least partially add the force to the vessel position force in order to maintain the floating vessel at the vessel target location while simultaneously exerting the force onto the pile.

In some embodiments of the assembly, the pile guiding frame comprises an annular portion.

In a different invention, a method is provided for damping roll and/or pitch motions of a floating vessel, wherein the vessel comprises a pile guiding system, the pile guiding system comprising:
a base provided on the vessel,
a pile guiding frame connected to the base, the pile guiding frame being configured to accommodate and guide a pile during installation thereof,
at least one primary actuator for moving the pile guiding frame relative to the base in a plane substantially parallel to a deck of the vessel,
   wherein the method comprises, when the pile guiding frame does not accommodate a pile, moving the pile guiding frame with the at least one primary frame actuator towards a centre of gravity of the vessel when the pile guiding frame moves downwards relative to the centre of gravity of the vessel caused by a roll motion and/or a pitch motion of the vessel, and/or moving the pile guiding frame away from the centre of gravity of the vessel when the pile guiding frame moves upwards relative to the centre of gravity of the vessel caused by of a roll motion and/or pitch motion of the vessel.

Advantageously, pile guiding system can be used for a second function, namely to reduce motions of the vessel.

In some embodiments of the method, the pile guiding system comprises a first primary actuator for moving the pile guiding frame in a first direction relative to the vessel, and a second primary frame actuator for moving the pile guiding frame in a second direction relative to the vessel, the second direction being substantially perpendicular to the first direction.

In some embodiments of the method, the first primary actuator and second primary actuator are configured to together move the pile guiding frame in all directions in the plane substantially parallel to the deck of the vessel.

In some embodiments of the method, the base and the pile guiding frame is provided at a location on the vessel between 40-60% of a length of the vessel.

In some embodiments of the method, when seen in top view the pile guiding frame extends beyond a contour of the vessel, i.e., outboard of a hull of the vessel.

The words stiffness and resilience are intended to be synonyms.

### SHORT DESCRIPTION OF THE FIGURES

Embodiments of the system and the method will be described by way of example only, with reference to the accompanying schematic drawings in which corresponding reference symbols indicate corresponding parts, and in which:

FIG. 1 through 6 show diagrams explaining the background of the invention.

FIG. 7 shows the floating vessel with the monopile.

FIG. 8 shows a top view of the pile guiding system.

FIG. 9A shows a diagrammatic view of the guiding control unit.

FIG. 9B shows an embodiment of a control loop according to the present invention.

FIGS. 10 through 14 shows stages in the installation of a monopile.

FIG. 15 shows another embodiment of the present invention.

FIGS. 16 and 17 shows a different aspect of the invention.

FIG. 18A shows an example of the forces in the system without the present invention.

FIG. 18B shows an example of the dynamics of the system with the present invention in action.

FIG. 19 shows the vessel thrust force and the gripper force as a function of time.

FIG. 20 shows an example of the forces in the system without the present invention.

FIG. 21 shows an example of the dynamics of the system with the present invention in action.

### DETAILED DESCRIPTION OF THE FIGURES

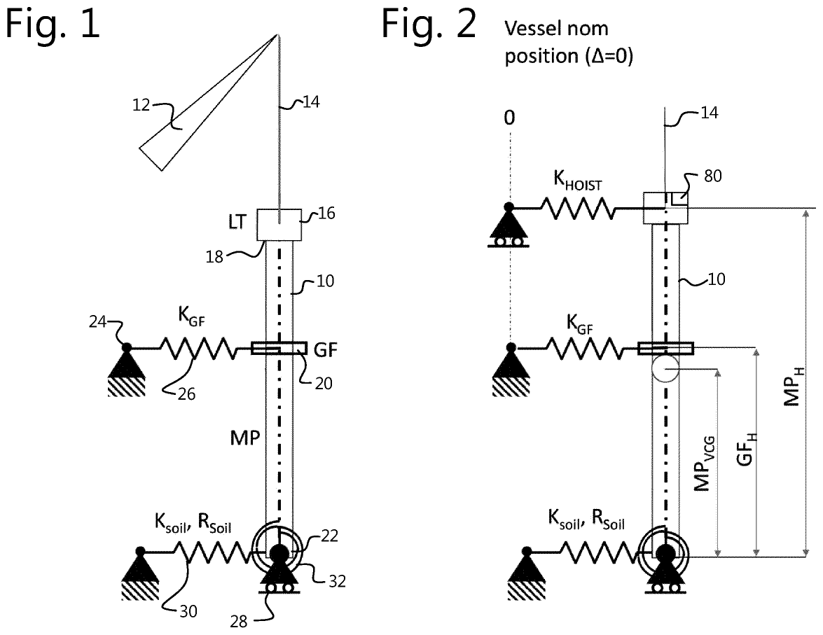

Turning to FIGS. 1 and 2, a diagram of the forces in the system is shown. A monopile 10 is suspended from a crane 12 via a crane line 14 and a lift member 16. The lift member is connected to an upper end 18 of the monopile. A pile guiding frame 20 extends around the monopile at a position which is between the lower end 22 of the monopile and the upper end 18. The pile guiding frame 20 is connected to the floating vessel, indicated with 24. Element 24 is shown as a fixed element. This is explained further below. The connection between the pile guiding frame 20 and the floating vessel 24 is shown as a spring 26 with stiffness Kgf.

The lower end 22 of the monopile is shown to be in contact with to the seabed. When the lower end of the monopile touches the seabed, the lower end is initially not completely fixed and may move sideways somewhat. The seabed is shown as a combination of a linear spring 30 with stiffness Ksoil and a rotational spring 32 with stiffness R soil.

FIG. 2 shows the various lengths and distances which are relevant. The monopile 10 has a vertical orientation. The floating vessel is in the target position. The crane line is represented as a horizontal spring Khoist. FIG. 2 focuses on horizontal contributors.

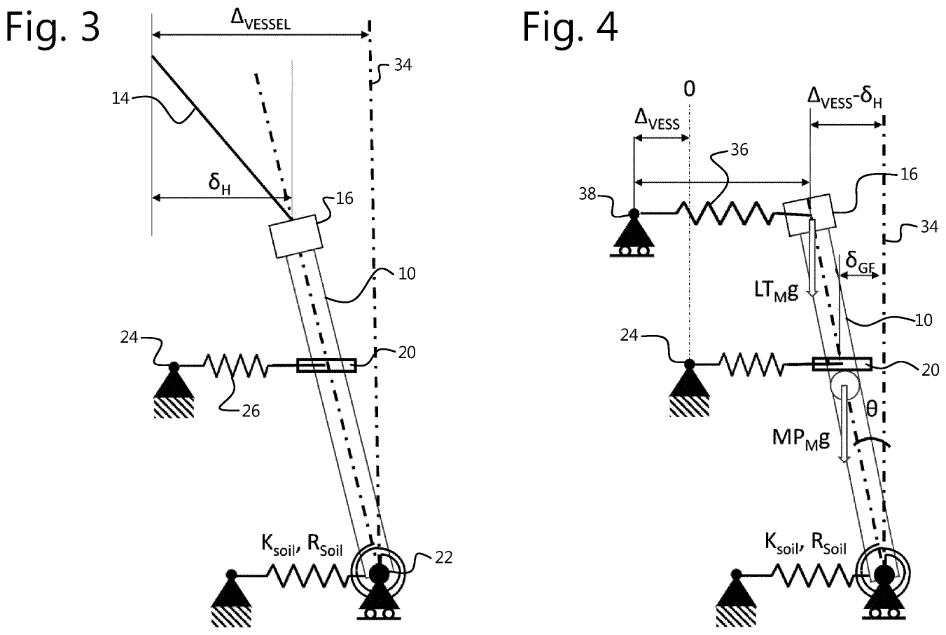

Turning to FIGS. 3 and 4, a situation is shown in which the floating vessel has moved to the left, away from its target position over a distance Δvess (Δvessel). The monopile 10 has tilted over an angle θ. Due to the tilting, the upper end of the monopile (the lift member 16) has also moved to the left. The vessel has moved relative to the upper end (the lift member) of the monopile over a distance δ_{H}. The upper end of the monopile has moved to the left over a distance Δvess minus δ_{H}. The crane line 14 now pulls the monopile 10 away from its vertical target position 34. LTmg indicates the weight of the lift member. MPmg indicates the weight of the monopile and is located at the centre of gravity of the monopile. Δgf indicates the displacement of the pile guiding frame 20 relative to earth.

In FIG. 4 the horizontal component of the crane line 14 stiffness is modelled as a spring 36 connected to a movable point 38. Because the floating vessel has moved away from its target position, the movable point 38 is shown as having moved to the left, over the distance Δvessel. The vessel pulls to the left on the upper end of the monopile and the horizontal pull force is determined by the stiffness of the spring 36, which is a function of the rigging length and the pull force in the crane line 14.

Point 24 is fixed because the pile guiding frame 20 is compensating with respect to earth. The weight of the monopile 10 and the weight of the lift member 16 also create moments about the bottom end of the monopile which contribute to the further tilting of the monopile. If no counter measure is taken, the monopile will fall over due to the pulling of the crane line 14 and the moments created by the weight of the monopile and lift member.

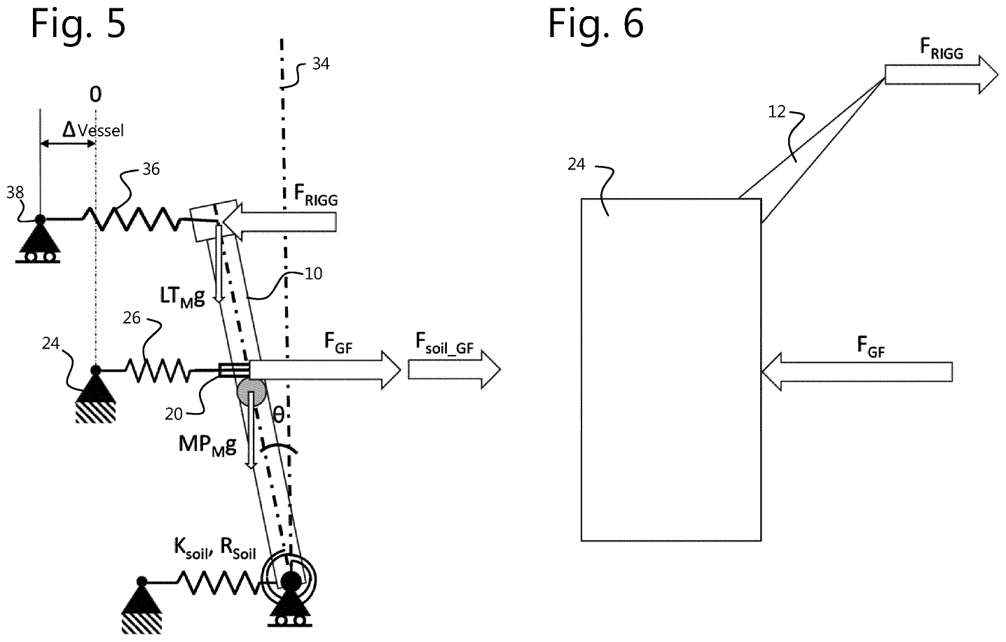

Turning to FIG. 5, the pile guiding frame 20 needs to exert a force Fgf on the monopile to prevent the monopile from falling over and more in particular to move the monopile back to its target position. This is done by actively controlling the pile guiding frame with actuators.

Turning to FIG. 6, the forces on the vessel 24 are shown. The crane line 14 pulls on the vessel with a force having a horizontal force component Frigg. There is also a vertical component in the force of the crane line, but the vertical component is not shown. The pile guiding frame 20 pushes the vessel with a force Fgf which is the reaction force of the force with which the pile guiding frame pushes against the pile.

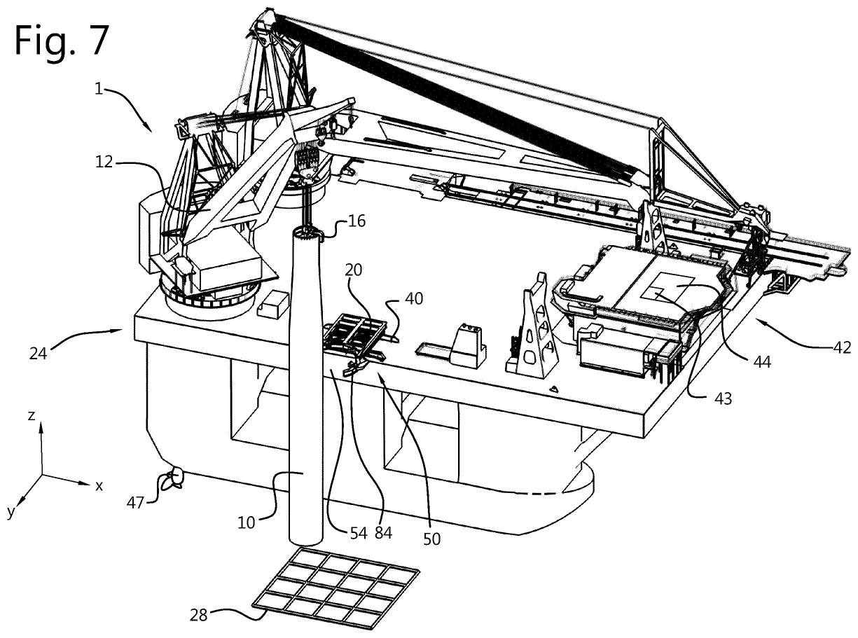

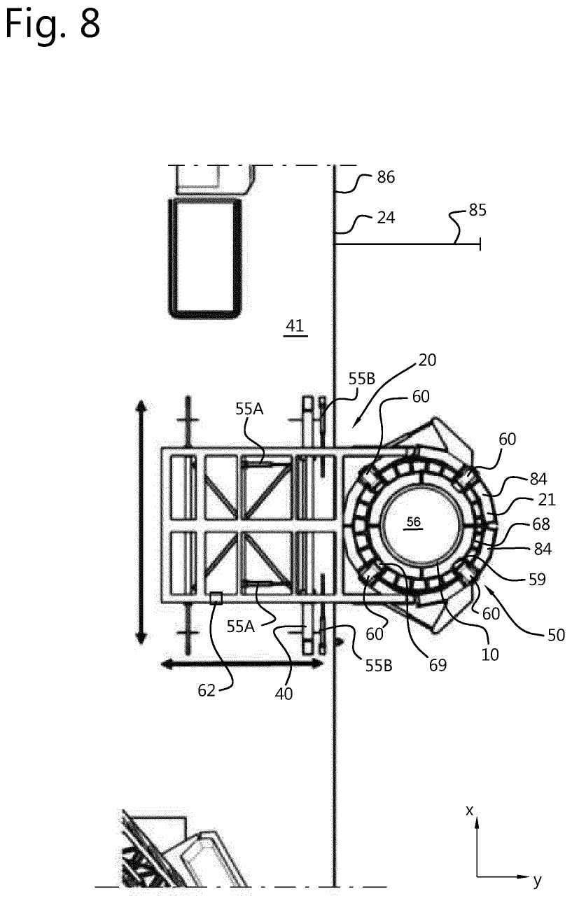

Turning to FIGS. 7 and 8, the various components of the assembly 1 according to the present invention are shown. The assembly 1 is configured for lowering a monopile (or in short: pile) 10 onto and partially into a seabed 28 (schematically indicated with a grid). The assembly comprises the floating vessel 24. The floating vessel comprises a vessel positioning system 42, diagrammatically indicated. The vessel positioning system will typically be a DP-system with a plurality of thrusters 47 such as azimuth thrusters, but may also comprise mooring lines and controllable winches. The vessel positioning system maintains the floating vessel at a vessel target location 45.

The crane 12 is provided on the vessel and is configured for lowering the pile 10 onto and partially into the seabed 28. The crane 12 comprises a lift member 16 configured to be connected to the pile, in particular to the upper end of the pile.

The assembly further comprises a pile guiding system 50 configured to guide the pile during the lowering thereof by the crane. The pile guiding system comprises the base 40 which is mounted to the vessel. In this embodiment, the base 40 is mounted on the deck 41 of the vessel 24. The base 40 may also be mounted to the side of the hull or to a different position on the vessel. The pile guiding system 50 comprises at least one pile guiding frame 20 defining a through passage 54. The pile guiding frame is connected to the base via at least one primary actuator 55. The at least one primary actuator 55 may be a hydraulic actuator such as a hydromotor or a hydraulic cylinder, a pneumatic actuator, and/or an electric drive.

The pile guiding frame 20 and in particular an annular portion 21 thereof, defines a through passage 56 through which in use the pile extends. The pile guiding frame is configured to guide the pile during the lowering thereof. The pile guiding frame 20 is further configured to transfer a force (F) to the pile, wherein the force has a horizontal component.

The pile guiding system 50 comprises the primary actuators 55A, 55B which are configured for moving the pile guiding frame 20 relative to the base 40. In FIG. 8, two primary actuators 55A which move the pile guiding frame in the Y-direction and two primary actuators 55B which move the pile guiding frame in the X-direction are shown. The X-direction is the longitudinal direction of the vessel, the Y-direction is the lateral direction of the vessel. These are commonly indicated as primary actuators 55. The primary actuators provide force which is required to restore the pile guiding frame 20 (and with it the monopile) to its target position. The primary actuators 55 interconnect the base 40 and the pile guiding frame 20.

The pile guiding system and the pile guiding frame thereof is configured to exert only forces onto the pile and is configured to not exert any bending moments onto the pile. The roller which engages the monopile via the secondary actuator does not transfer moments, by hinging, rolling and/or having a limited height.

The annular portion of the pile guiding frame in particular comprises one or more doors 84 configured to move between an open position and a closed position, wherein the open position allows a pile 10 to be laterally introduced in the through passage 56.

The pile guiding frame extends outboard of the hull and extends over a horizontal distance 85 away from a hull 86 of the vessel.

Generally, the pile guiding frame 20 can move relative to the base over a finite stroke length in both X and Y direction. The stroke length is determined by the length of the primary actuators 55. The force can be controlled and maintained below the predetermined maximum vessel force as long as the pile guiding frame does not reach the end of the stroke length.

The pile guiding frame 20 comprises the annular portion 21 (also called annular subframe 21). The pile guiding system 50 further comprises one or more secondary actuators 60 which are connected to the pile guiding frame 20 and extend at least partially inward from the annular portion of the pile guiding frame 20. The one more secondary actuators 60 are configured for maintaining the pile in a pile target position within the pile guiding frame. Four secondary actuators 60 are shown but a different, larger number is also possible. Each secondary actuator 60 has a free inner end 69 at which a slider or roller 59 may be provided to allow the monopile to slide or roll through the through-passage.

The pile guiding system comprises at least one frame position sensor 62 for measuring an excitation parameter indicative of an excitation of the pile guiding frame relative to a pile guiding frame target position. The frame position sensor 62 may be mounted on the frame or on a part of the vessel. The frame position sensor 62 measures the excitation of the pile guiding frame relative to a point on earth. In another variant, frame position sensor 62 measures the excitation of the pile guiding frame relative to the vessel, and in this variant the position of the vessel relative to earth should be measured also. The excitation of the pile guiding frame relative to earth can then be derived from these two measurements.

### The Guiding Control Unit-inner Feedback Loop

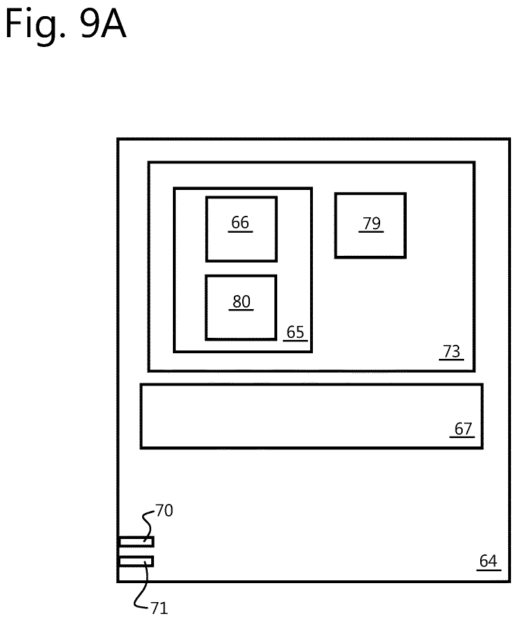

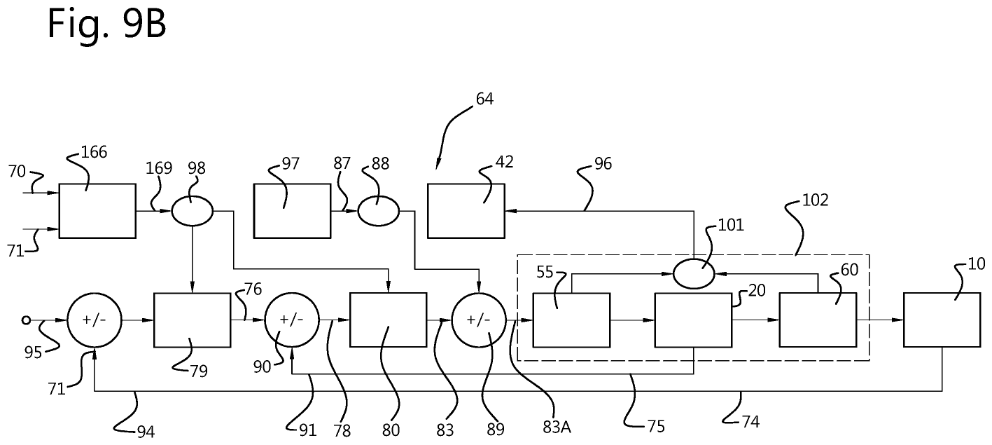

With reference to FIGS. 9A and 9B, the pile guiding system 50 comprises a guiding control unit 64 which controls the overall process of lowering the pile onto the seabed.

The guiding control unit 64 has an active control mode 65 in which, when activated, the one or more primary actuators are actively controlled in order to return the pile guiding frame to the target position, and a proportional-control-mode 67 in which, when activated, the proportional gain (P) is set to a certain value and the integral gain (I) is set to zero. In the proportional control mode, the pile guiding frame is not actively returned to the target position. The guiding control unit 64 can be switched from the proportional-control-mode 67 to the active control mode 65.

The guiding control unit 64 further has an inclination mode 73, which is optional. The active control mode 65 can be activated with the inclination mode 73 switched on (activated) but can also be activated with the inclination mode 73 switched off (deactivated). The guiding control unit 64 is configured to be switched from the proportional-control-mode 67 to the active control mode 64 at some point during the lowering of the pile into the seabed. When the guiding control unit 64 is switched from the proportional-control-mode 67 to the active control mode 66, the inclination control mode will initially be switched off (deactivated). Optionally, near or at the end of the lowering process, the inclination control mode 73 can be activated.

The guiding control unit 64 has several parts which are in particular active during the active control mode 65.

Turning in particular to FIG. 9B, a central part of the guiding control unit 64 is formed by an inner feedback loop 75. The inner feedback loop 75 comprises an excitation controller 80 configured to control the at least one primary actuator 55 and optionally the at least one secondary actuator 60 in dependence of an excitation 78 of the pile guiding frame 20. The excitation controller 80 may be a PID controller or a variant thereof. In a comparison 90, a measured position 91 of the pile guiding frame relative to the vessel in the X-direction (longitudinal direction of the vessel) and Y-direction (lateral direction of the vessel) is compared with a target position 76 of the pile guiding frame relative to the vessel. The difference between these two is the excitation 78 of the pile guiding frame 20 in the X-direction and Y-direction. This difference is used as input for the excitation controller 80.

The pile guiding frame target position 76 may be a point on earth, and the guiding control unit may be configured to control the primary actuator and optionally the secondary actuator independently from the location of the floating vessel.

In this embodiment, the excitation controller 80 outputs a speed 83 to the primary actuator 55 and/or to the secondary actuator 60. Alternative configurations are possible in which the excitation controller outputs a power or a force to the primary actuator 55 and/or to the secondary actuator 60.

In the embodiment of FIG. 9B, the motions of the floating vessel are measured with an MRU 97 (Motion Reference Unit). The MRU 97 is not part of the guiding control system but rather part of the vessel 24. The MRU 97 measures accelerations, which are converted into a speed by integrating the accelerations over time. The MRU outputs the vessel speed to the guiding control unit via input 87, which has an on/off switch 88. The on/off switch 88 indicates the optional character of this signal. If the MRU 97 is used, the vessel speed 87 is subtracted from the new speed 83 which is output by the excitation controller 80 in a subtraction 89 in order to calculate an adjusted speed 83A which is fed to the ‘physical system’ indicated by dashed line 102. The physical system comprises the primary and secondary actuator(s) and the pile guiding frame 20. The adjusted speed 83A is then outputted to the primary actuators 55 and secondary actuators 60.

In this embodiment the guiding control unit is configured to control the primary actuator 55 and optionally the secondary actuator 60 to cause the pile guiding frame to make an opposite movement as the movement of the floating vessel. The pile guiding frame is moved back to the pile guiding frame target position in case of an excitation of the pile guiding frame relative to earth. Such an excitation may occur as a result of external forces on the pile and/or as a result of drifting of the vessel. In this way the position of the pile guiding frame stays constant relative to earth.

The speed 83 and the adjusted speed 83A may be expressed in rpm or in m/s or in a different unit.

In some embodiments, the primary actuators 55 are actively controlled and the secondary actuators 60 are set in a passive mode, with only a proportional gain (P) set to a value above zero. The secondary actuators then essentially become springs. In case of hydraulic actuators, the pressure of the hydraulic liquid can be set at a certain level, resulting in a certain spring constant (or stiffness) in N/m. During the lowering, the pressure can be increased, thereby increasing the stiffness (spring constant).

The opposite variant in which the primary actuators 55 are set in passive mode and only the secondary actuators 60 are actively controlled, is also possible. In this embodiment, in case the pile guiding frame has an excitation relative to the pile guiding frame target position (which is a position relative to earth), the excitation controller 80 controls the speed of the one or more secondary actuators 60 for moving the pile in the opposite direction as the pile guiding frame, thereby maintaining the position of the pile relative to earth.

It is also possible that the excitation controller 80 actively controls both the primary actuators 55 and the secondary actuators 60.

### The Guiding Control Unit-outer Feedback Loop

The guiding control unit 64 may comprise an outer feedback loop 74. The outer feedback loop 74 is optional. The outer feedback loop comprises an inclination controller 79 which is configured to—in the inclination mode—adjust the pile guiding frame target position 76 in dependence of the pile inclination input 71. The inclination controller 79 is configured to provide the inner feedback loop 75 with the updated pile guiding frame target position 76. The pile inclination input is determined by subtracting a measured pile inclination 94 (θ) with a setpoint 95 for the pile inclination. The setpoint will generally be zero (vertical).

The pile guiding system 50 may comprises a pile inclination sensor 80 for measuring the inclination angle θ of the pile, the pile inclination sensor providing the pile inclination 94 (θ).

The pile inclination sensor 80 may be mounted on the lift member 16 or in the monopile 10 itself, or may comprise one or more cameras configured to register the inclination of the pile visually. Other sensors are also possible.

The inclination controller 79 of the outer feedback loop 74 may be a pure P-controller, i.e. without an integrating (I) gain or a derivative (D) gain. The integrating action is carried out indirectly, by adjust the pile guiding frame target position 76 which is eventually reached by the integrating factor of the excitation controller 80.

With the inclination mode, the pile can be oriented vertically, which is not possible with the active control mode. The pile guiding system 50 is configured to activate the inclination mode when the lift force drops below a predetermined inclination control threshold lift force which may be a percentage of an initial lift force exerted by the crane on the pile before the pile touches the seabed. The inclination control threshold lift force may in particular be less than or equal to 90 percent of an initial lift force which is exerted by the crane before the pile touches the seabed, and may be about 50 percent.

### The Guiding Control Unit-resilience Controller

The guiding control unit 64 further comprises a resilience controller 166 configured to control a resilience of the one or more primary actuators 55 and/or secondary actuators 60 during the lowering of the pile into the seabed. In this way, the force between the pile and the vessel can be limited depending on the lift force exerted by the crane. The resilience controller 166 controls the resilience of the one or more primary actuators 55 and/or secondary actuators via the proportional gain P of the excitation controller 80. This proportional gain P can be adjusted via the resilience output 169.

In some embodiments, the excitation controller 80 may control the one or more primary actuators 55 and/or secondary actuators in dependence of characteristics of the vessel positioning system 42. The vessel positioning system 42 is not considered part of the guiding control unit 64, because it is functionally linked to the installation vessel 24 itself.

The resilience controller 166 controls the stiffness of the primary and/or secondary actuator in order to maintain the force exerted by the pile on the vessel below a predetermined maximum vessel position force which can be delivered by the vessel positioning system 42 or at least to ensure that this force does not exceed the maximum vessel position force too long. The resilience controller 166 performs this function by maximizing the proportional term P and/or the integral term I of the excitation controller, in particular to a value below the maximum vessel positioning force. In this way the force exerted by the primary and/or secondary actuator 55, 60 is be maximized to a value which lies below the maximum vessel positioning force, or at least it is ensures that the force exerted by the primary and/or secondary actuator 55, 60 does not exceed the maximum vessel positioning force too long. ‘Too long’ in this context means that the force exerted by the primary and/or secondary actuator 55, 60 should drop below the maximum vessel positioning force soon enough to let the vessel positioning system move the vessel back toward the pile before the primary and/or secondary actuators reach the end of their stroke length.

In this way, a potential instability in the initial phase when the crane still carries the greater part of the weight of the monopile (and the lift member) is avoided. At the start of the lowering process, when the major part of the weight of the pile is carried by the crane, the stiffness (proportional gain P) will be set at a relatively low value. During the lowering of the pile, the stiffness will be increased. This increase may be gradual but may also be a step-function at a certain stage in the lowering process. In this way the system becomes stiffer during the lowering of the pile.

When the seabed carries a substantial part of the weight of the monopile (and the lift member), the risk of instability is reduced or no longer present, and the stiffness can be increased. The increased stiffness results in a smaller excitation of the pile and therefore a better verticality of the pile.

Further, the stiffness of the primary and/or secondary actuators 55, 60 may be limited in view of a maximum rate of change of the vessel position force which the vessel positioning system can deliver. The excitation controller 80 may be configured to limit the rate of change of the output signal 83 (which is generally a speed), thereby limiting the rate of change of the force exerted by the primary actuators 55 and/or secondary actuators 60, and to match this rate of change to the maximum rate of change of the vessel positioning system 42. This allows the vessel position force 120 exerted by the vessel positioning system to follow or substantially follow variations in the force 121 exerted by the primary actuator and/or secondary actuator.

The resilience controller 166 may be configured to receive a lift force parameter representative of a lift force exerted by the crane on the pile via the input 70. Alternatively, the input 70 of the resilience controller 166 may be the elevation of the pile during lowering. The elevation can be measured directly on the pile or indirectly on a winch onto which the crane line 14 is spooled. Alternatively or additionally, the resilience controller 166 may also be controlled manually and may have a manual input 71 to this end. With the manual input 71, an operator can control the proportional gain, integral gain and/or derivative gain of the excitation controller 80 in order to adjust the stiffness of the primary and/or secondary actuator 55, 60. This may be useful if for instance during operation the operator observes that the frequency of incoming waves is equal to or substantially equal to the natural frequency of the combination of the pile and the gripper frame, resulting in resonance and increasing excitations of the gripper frame and the upper end of the pile. In that case, the operator can manually adjust the stiffness of the primary and/or secondary actuator 55, 60 to adjust the natural frequency of the combination of the pile and gripper frame. In this way the operator may create a (greater) difference between the natural frequency of the combined pile and gripper frame and the frequency of the incoming waves, in order to stop or at least reduce the resonance. With the manual input 71, at least the proportional of the primary and/or secondary actuator 55, 60 gain can be changed.

The resilience controller 166 may control the resilience by controlling a maximum speed of the one or more primary actuators 55 and/or the one or more secondary actuators 60. The output speed is speed 83 shown in FIG. 9B.

Alternatively, the output 83 of the excitation controller 80 may be a power (e.g. in Kilowatt). In that case, the resilience controller 166 may control the resilience by controlling a maximum power 83 which is output by the excitation controller and fed to the one or more primary actuators 55 and/or the one or more secondary actuators 60. In this embodiment, the motion signal 87 from the MRU 97 is processed differently, namely in the excitation controller 80 instead of downstream from the excitation controller.

Alternatively, the output 83 of the excitation controller 80 may be a force which is directly communicated to the one or more primary actuators 55 and/or the one or more secondary actuators 60.

In case of a hydraulic actuator, the maximum force may be controlled by controlling the maximum hydraulic pressure in the primary actuators 55.

As discussed above, the guiding control unit 64 may comprise an active control mode 66 in which the one or more primary actuators 55 and the one or more secondary actuators 60 are actively controlled by setting the proportional gain (P) and the integral gain (I) to a certain value and a proportional-control-mode 67 in which the proportional gain (P) of the at least one primary actuator is set to a certain value and the integral gain is set to zero. This may be implemented in the resilience controller 166 which may switch the excitation controller 80 from the proportional-control-mode 67 to the active control mode 66 during the lowering of the pile when the lift force received via input 70 which receives a signal representative for a lift force exerted by the crane. The resilience controller switches the excitation controller from the proportional-control-mode to the active control mode when the lift force exerted by the crane drops below an active control threshold lift force which may be a percentage of an initial lift force exerted by the crane on the pile before the pile touches the seabed. This allows the active control mode to be switched on before the system as a whole becomes unstable.

In the proportional control mode, the resilience controller 166 sets the proportional gain P of the excitation controller 80 at a certain value and sets the integral gain I and the derivative gain D to zero. In this way, the at least one primary actuator 55 and/or the secondary actuator 60 are configured to act as a spring. In the active control mode, the resilience controller 166 sets at least the integral gain I of the excitation controller at a certain value above zero and thereby actively maintains the pile guiding frame at the target position.

The pile guiding system may comprise at least one damping member for providing a damping connection between the pile and the floating vessel. In the proportional-control-mode, the actuators are the damping members and limit the forces between the pile and the vessel.

The element 98 in the guiding control unit 64 is an and/or box which indicates that the resilience controller 166 may be used to activate the inclination mode 73 in which the inclination controller 79 becomes active. Optionally, the resilience controller may further control the proportional gain P of the inclination controller 79. An increase of the proportional gain P of the inclination controller 79 results in a faster reorientation of the monopile 10 to a vertical orientation. In other words, the resilience controller 166 may control the resilience of the excitation controller 80 and/or control the proportional gain of the inclination controller 79.

In some embodiments, the pile guiding system comprises at least one pile position sensor 190 for measuring an excitation of the pile relative to a pile target position within the annular portion 21 of the pile guiding frame, and the excitation controller 80 of the guiding control unit 64 controls the one or more primary and/or secondary actuators 60 in dependence of the measured excitation of the pile relative to the pile target position to move the pile to the pile target position in case of an excitation of the pile relative to the pile target position

The secondary actuators 60 may be set with pre-tension in order to press against the pile from all sides. This will maintain the pile in the center of the annular portion of the pile guiding frame.

### Feed Forward to Vessel Positioning System

FIG. 9B also shows the vessel positioning system 42, which comprises:
at least one vessel location sensor 43 (see FIG. 7) for measuring the location of the floating vessel relative to the vessel target location,
at least one thruster 47 (see FIG. 7) and/or at least one anchor winch configured for exerting a vessel position force,
a vessel position control unit 44 (see FIG. 7) configured for controlling the vessel position force in dependence of the measured vessel location for maintaining the floating vessel at the vessel target location.

The vessel positioning system 42 is coupled to the guiding control unit 64 via the feed-forward signal 96. The feed forward signal 96 is communicated from the primary and/or secondary actuators 55, 60 to the vessel positioning system 42 (the DP-system). Element 101 indicates that the forces of the primary and/or secondary actuators 55, 60 are combined in the feed forward signal. The feed forward signal is used by the vessel positioning system 42 by at least partially adding the force exerted by the primary and/or secondary actuators 55, 60 to the force required for position keeping and thereby reduces or avoids a reduction in the position keeping capacity. This works as long as the DP-system has sufficient capacity to generate this extra force. In this way the floating vessel is maintained at the vessel target location while simultaneously exerting the force onto the pile 10.

Alternatively, the guiding control unit 64 may communicate the position of the pile guiding frame 20 to the vessel positioning system 42 instead of the force exerted by the primary and/or secondary actuators 55, 60. The vessel positioning system 42 may then convert this position into a force which is added as a feed forward signal to the vessel position force.

### Operation

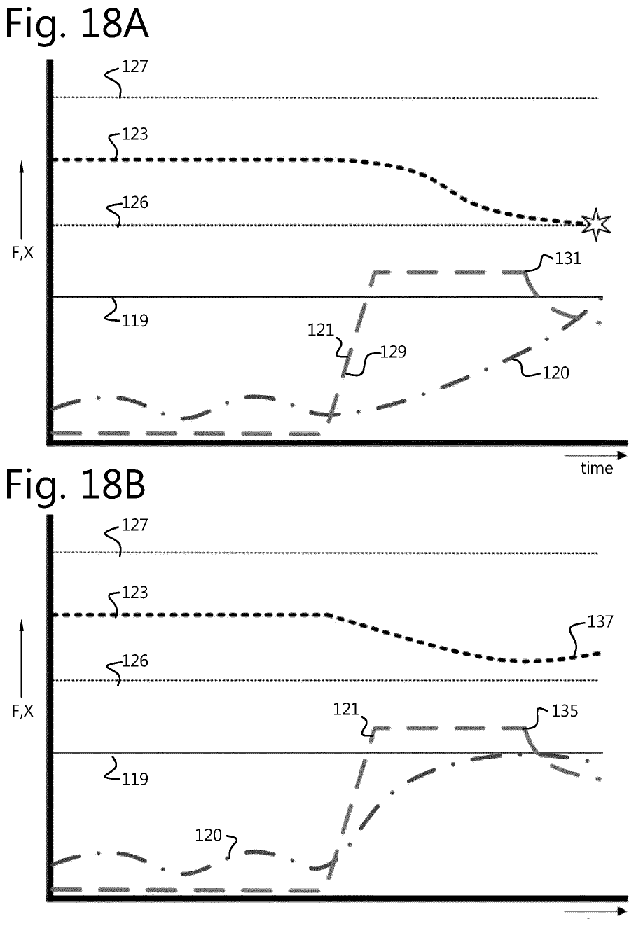

Turning to FIG. 18A, the lowering of a monopile by a vessel having a pile guiding frame without the present invention is shown. The pile guiding frame is relatively stiff and there is no feed forward signal. Three graphs 120, 121, 123 are shown in a single XY coordinate system, namely the thrust force 120 (also called vessel positioning force) of the vessel positioning system 42, the gripper force 121 (force between the pile guiding frame and the vessel) and the vessel position 123.

Three horizontal lines are further shown. In practice, the vessel positioning system 42 is capable of delivering a vessel position force 120 up to a maximum vessel position force 119 which is indicated with a first horizontal line. The vessel position force 120 can be changed with a limited rate of change. The primary actuator 55 is mechanically capable of delivering a greater gripper force 121 than the maximum vessel position force 119 of the vessel positioning system. In other words, in FIG. 18, the pile guiding frame is relatively stiff. Further, the primary actuator 55 is capable of varying this gripper force 121 at a greater rate of change than the maximum rate of change of the thrust force 120 of the vessel positioning system. It can also be seen that the gripper force 121 is maximized.

FIG. 18A also shows the vessel position 123 and the boundaries 126, 127 within which the vessel should stay to prevent the primary actuator 55 and/or secondary actuator 60 from reaching the end of its stroke. The boundaries 126, 127 are shown as second and third horizontal lines. FIG. 18A shows a situation in which a wave hits the pile and causes an initial displacement of the pile and the pile guiding frame 20 relative to earth at section 129. As a result, the gripper force 121 exerted by the primary actuator 55 and/or the force exerted by secondary actuator 60 is increased by the excitation controller 80 of the guiding control unit 64 in order to push the pile guiding frame 20 (in case of the primary actuator 50) respectively the pile 10 (in case of the secondary actuator 60) back to its target position. Because of the gripper force and because the vessel positioning system 42 responds relatively slow (the thrust force 120 is increased relatively slowly), the vessel is gradually pushed away from the pile. This occurs quite slowly, because the vessel has a much larger inertia than the pile.

In FIG. 18A the gripper force 121 rises to above the maximum vessel position force 119 of the vessel positioning system 42. Consequently the thrusters 47 cannot provide a sufficiently high vessel position force 120 to keep the vessel in position, even if they would respond fast enough, which they do not. This does not necessarily result in instability, as long as this situation is temporary and as long as there is sufficient stroke length of the primary actuator 55 and/or secondary actuator available. However, in FIG. 18A this situation occurs too long. Although the force of the wave has already reversed at 131, the inertia of the vessel is so large that the vessel continues to move. The vessel reaches the boundary 126 at which the primary and/or secondary actuators reach the end of the stroke. An accident occurs as indicated with numeral 132 in FIG. 18A. The vessel position force 120 from the DP system increases, but too slowly to prevent the accident. Damage may occur to the pile, the pile guiding frame and/or the vessel. This situation is to be avoided at all times.

FIG. 18B shows a situation with a relatively stiff setting of the proportional gain P and integral gain I of the excitation controller 80, resulting in relatively stiff primary and/or secondary actuators, and with a feed forward signal 96. The excitation controller 80 will only be set to a relatively stiff setting when the lift force exerted by the crane has decreased considerably, i.e. to about 0-20 percent of the original lift force. In other words, FIG. 18B shows a final stage of the lowering process. With the feed forward signal (see 96 in FIG. 9), the vessel positioning system 42 responds not only to a change in position of the vessel but also to a change in the force exerted by the primary and/or secondary actuators. As a result, the vessel positioning system 42 responds faster than when the vessel positioning system 42 would only respond to changes in the vessel position, which is shown in FIG. 18A.

In FIG. 18B, the primary actuator 55 (and/or the secondary actuator) pushes the pile guiding frame back to its target position, which in turn results in a smaller gripper force 121, indicated with numeral 135. All this time the vessel will have moved away from the vessel target position, but as soon as the gripper force 121 becomes smaller than the sum of the force of the vessel positioning system and the horizontal component of the lift force exerted by the crane, the vessel starts to move back to its target position, as indicated with numeral 137. In FIG. 18B no accident occurs. The vessel position force 120 approaches the maximum vessel position force 119 but does not reach it.

It is noted that a temporary difference in forces may occur when the vessel positioning system 42 cannot increase the vessel position force 120 at the same rate as the primary actuator 55 and/or secondary actuator 60. As long as sufficient stroke length of the primary actuator 55 and/or secondary actuator 60 is available and the force of the vessel positioning system 42 can catch up with the force of the primary actuator and/or secondary actuator before the primary actuator and/or secondary actuator runs out of stroke length, this does not result in an accident and may be acceptable. The inertia of the vessel is relatively large and provides the vessel positioning system 42 with time to increase the vessel positioning force.

The rate of change of the force 121 exerted by the primary actuator 55 and/or secondary actuator is dependent on the integral gain (I-factor) of the PID control algorithm of the excitation controller 80. The tuning of this integral gain I is therefore important. If the integral gain I is too high, the system may become unstable.

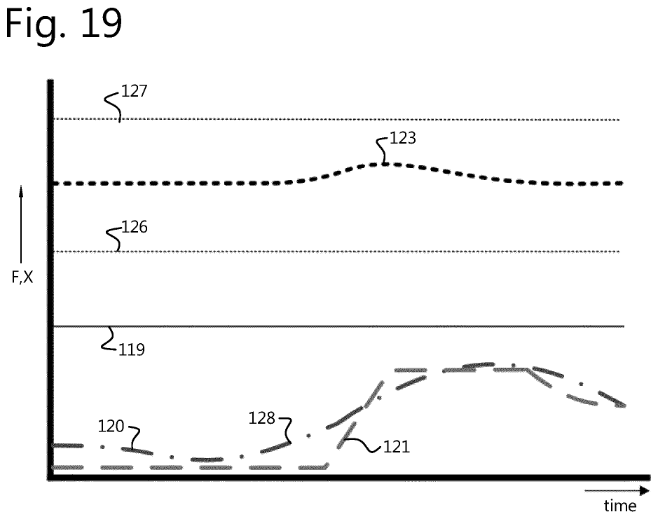

Turning to FIG. 19, a situation is shown in which the stiffness of the primary actuator 55 and/or secondary actuators 60 is reduced to maintain the gripper force 121 below the maximum vessel position force 119 of the vessel positioning system 42. The lower stiffness results in smaller movements of the vessel. This situation will typically occur at the start of the lowering process.

FIG. 19 also shows in a region indicated with numeral 128 that the thrust force 120 of the vessel positioning system 42 can be increased ahead of time, i.e. before the gripper force 121 is increased. This is possible for instance when the monopile 10 is inclined and when it is known that the inclination mode 73 will be activated at some point in time in the future, for instance 10 seconds from present.

The guiding control unit 64, in particular the resilience controller 166 of the guiding control unit, is configured to communicate inclination mode data to the vessel positioning system 42 before activating the inclination mode. The vessel positioning system 42 is configured to increase the vessel position force before the inclination mode is activated on the basis of the received inclination mode data. Hence, the vessel position force is increased ahead of the moment of activating the inclination mode 73. As a result, the vessel will initially be pushed slightly in the opposite direction. This is shown with graph 123 which has an opposite excitation than in FIGS. 18A, 18B. When the gripper force 121 kicks in, the vessel returns to its original target position. In this way the drift of the vessel is reduced.

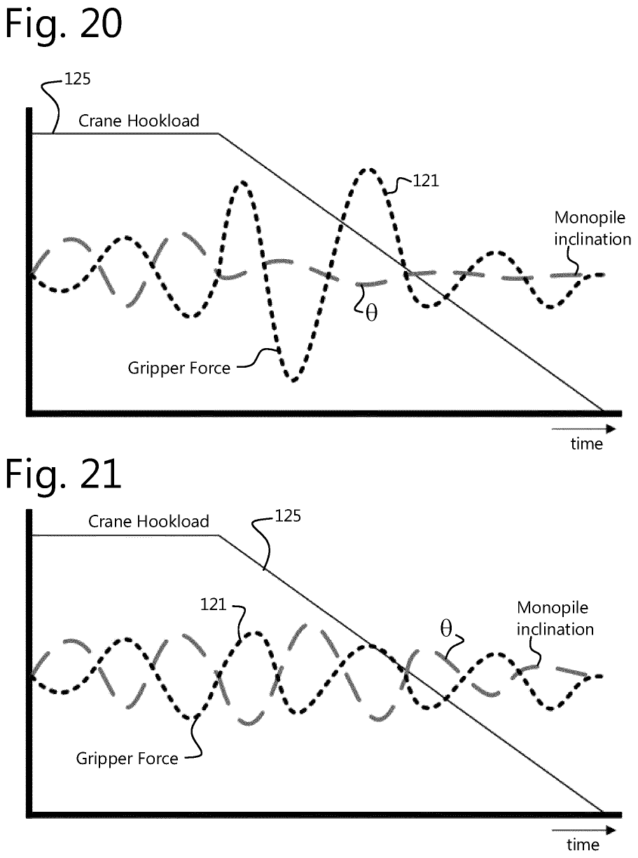

Turning to FIG. 20, the inclination θ of the monopile and the gripper force are shown in time in a configuration with a pile guiding frame. The lift force 125 exerted by the crane gradually decreases when the pile is inserted into the seabed. The primary actuator 55 is controlled to keep the pile guiding frame in the pile guiding frame target position. Alternatively, the secondary actuator(s) is controlled to let the monopile 20 make an opposite movement as the pile guiding frame 10. Because the settings of the proportional gain P and the integral gain I of the excitation controller 80 are relatively stiff, the force 121 exerted by the primary actuator 55 and/or secondary actuator becomes relatively high, resulting in a risk of damage to the pile and the equipment and possible instability in case the vessel cannot maintain its position. A positive effect of the stiff setting is that the inclination e of the monopile varies relatively little. As a result, the monopile stays relatively vertical. However, this does not weigh up to possible damage and/or instability which needs to be prevented in all situations.

FIG. 20 also shows that the gripper force is delayed relative to the inclination θ. This is due to latency and due to the integrating gain I of the excitation controller 80.

Turning to FIG. 21, with a softer setting of the excitation controller 80, resulting in a softer setting of the primary actuator 55 and/or the secondary actuator 60, the force 121 will vary less and stay within acceptable limits. In this way, damage to the pile/and pile guiding frame 20 and possible instability of the system can be avoided. The variations in the inclination θ of the monopile will be greater, but this is an acceptable effect of the softer setting, as long as the inclination can be reduced to within an acceptable boundary at the end of the lowering procedure.

In FIG. 21, the primary actuator 55 and/or the secondary actuator 60 become stiffer as the lift force 125 decreases, as shown by the reducing amplitude of the monopile inclination θ. This is controlled by the resilience controller 166. As a result, the variations in the inclination θ gradually decrease.

### Operation—Stages in the Lowering Process

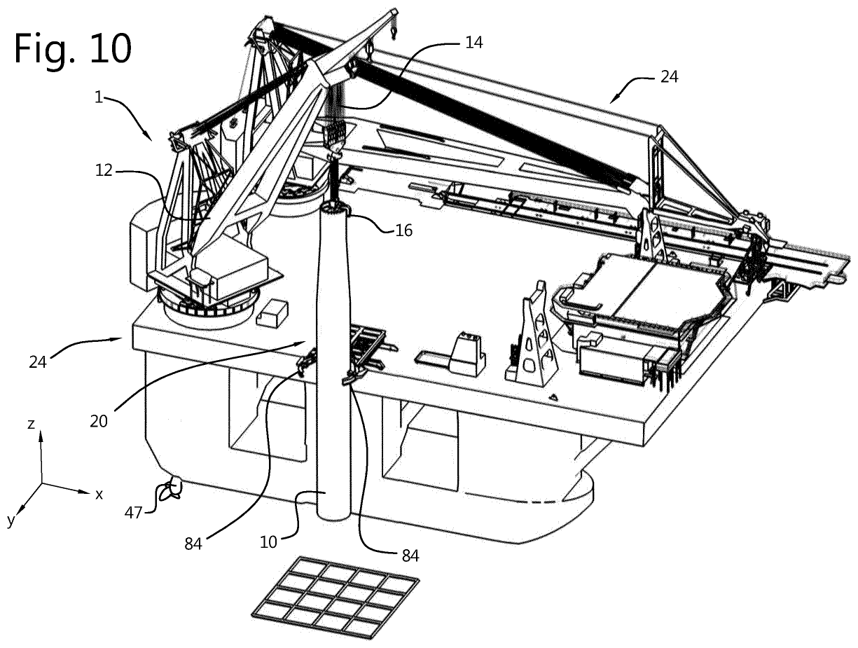

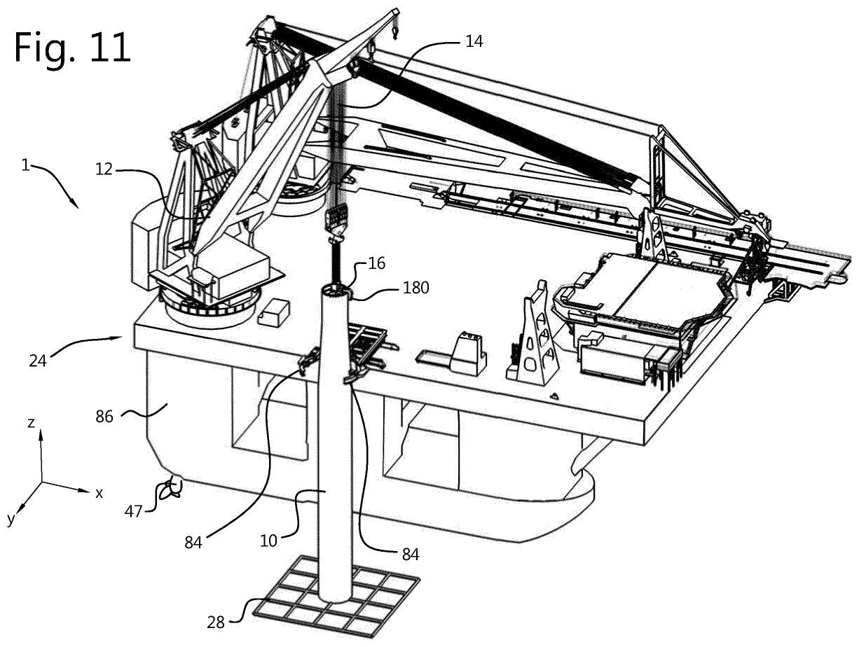

Turning to FIGS. 7, 10 and 11, in the method of lowering the monopile 10 onto and at least partially into a seabed 28 with a floating vessel 24, the floating vessel is positioned at a vessel target location which is directly adjacent the target position of the monopile. The monopile 10 is connected to the lift member 14 and the monopile is held in an upright or generally upright orientation. The doors 84 of the pile guiding frame 20 are opened and the monopile is received in the pile guiding frame of the pile guiding system.

The pile guiding system may comprise a pile inclination sensor 180 which is connected to the lifting member 16. The pile inclination sensor 180 measures the inclination angle of the pile, the pile inclination sensor being connected to the pile inclination input

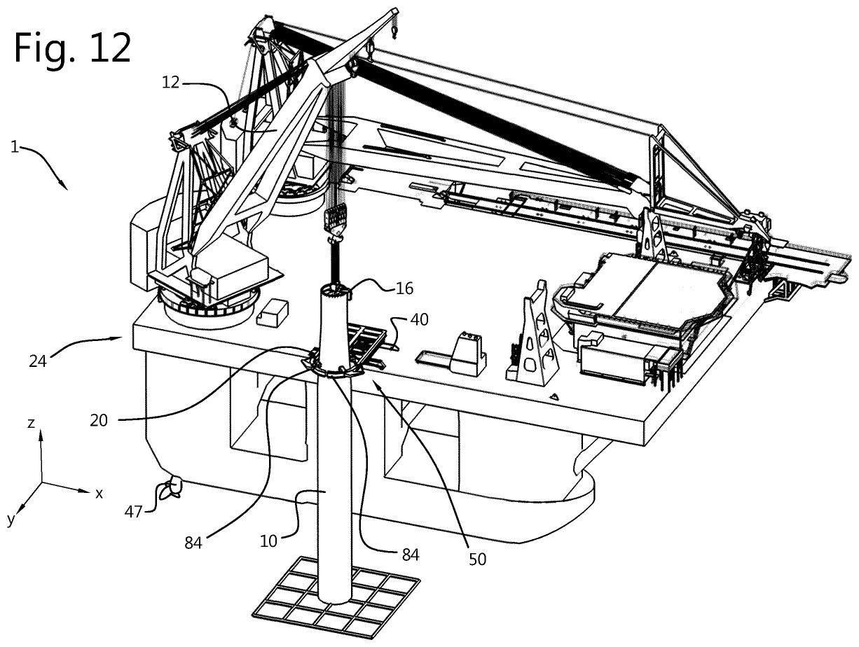

With reference to FIG. 12, next, the doors 84 are closed, and the pile 10 is located within the annular portion of the pile guiding frame 20.

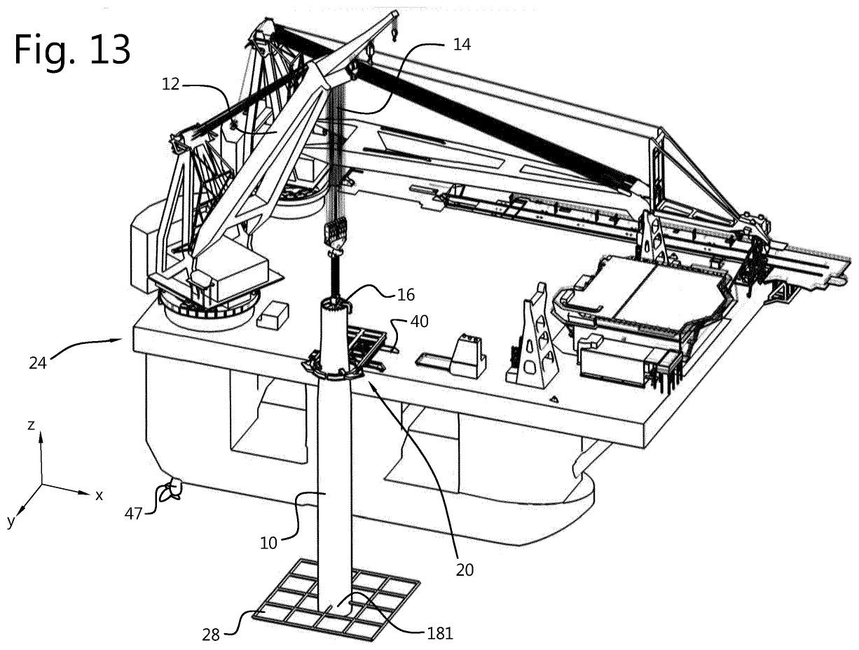

Next, the crane 12 lowers the monopile to the seabed. With reference to FIG. 13, at a certain point, the lower end 181 of the monopile 10 touches the seabed at the pile target location. From this point onward, the seabed will start to carry an increasing portion of the weight of the monopile 10 and the crane 12 will carry a decreasing portion of the weight of the pile. In this situation, the combined system of installation vessel 24 and monopile 10 may become unstable, resulting in large forces on the vessel which may potentially be greater than the maximum force of the DP system. An accident may occur and the monopile 10, the pile guiding frame 20 and possibly other components in the system may become damaged. This is what the present invention aims to prevent.

Under its own weight, the pile 10 penetrates the seabed 28 while being held at the upper end with the crane 12 and the lift member 16. At least during the penetration, the guiding control unit and in particular the excitation controller 80 thereof, controls the one or more primary actuators 55 in dependence of the measured excitation of the pile guiding frame 20 relative to the pile guiding frame target position to move the pile guiding frame to the pile guiding frame target position in case of an excitation of the pile guiding frame. If the secondary actuators are actively controlled, the excitation controller 80 controls the secondary actuators to let the monopile 10 make an opposite movement relative to the pile guiding frame as the pile guiding frame 20 moves relative to the pile guiding frame target position which is a position relative to earth.

During the lowering, the resilience controller 166 will increase the resilience (also referred to as stiffness) of the excitation controller, resulting in stiffer behaviour of the one or more primary actuators and/or the one or more secondary actuators. Initially, when the majority of the weight of the pile is carried by the crane, the stiffness will be relatively low in order to limit the force between the pile and the vessel and prevent instability. Subsequently, when the majority of the weight has been transferred to the seabed, the stiffness will be relatively high to reduce the excitations of the pile. The resilience controller 166 of the guiding control controls the resilience of the primary and/or secondary actuator 55, 60 by adjusting at least a proportional gain P of the excitation controller 80. Additionally, the integral gain I of the excitation controller 80 may also be increased.

During the lowering process the proportional term of the excitation controller (error e multiplied by proportional gain P) may be maximized in order to prevent the force from increasing further once the excitation of the pile guiding frame 20 rises above a certain threshold value. If the output 83 of the excitation controller 80 is a speed this can be done by setting a maximum output speed 83, thereby maximizing the speed of the one or more primary actuators and/or the one or more secondary actuators. If the output 83 is a force, this can be done by setting a maximum output power 83 with which the one or more primary actuators and/or the one or more secondary actuators are actuated. If the output 83 is a force, this can be done by setting a maximum output force which is exerted by the one or more primary actuators and/or the one or more secondary actuators.

During the lowering of the monopile, the guiding control unit 64 communicates the force exerted by the at least one primary actuator 55 and/or the at least one secondary actuator 60 as a feed forward signal to the vessel positioning system 42. The vessel positioning system may at least partially add the force to the vessel position force required for position keeping in order to maintain the floating vessel at the vessel target location while simultaneously exerting the force onto the pile.

In some embodiments, the excitation controller 80 of the guiding control unit 64 controls the primary actuators 55 and/or secondary actuators in dependence of characteristics of the vessel positioning system, in particular in dependence of a maximum rate of change of the vessel position force which the vessel positioning system can deliver, in order to allow the vessel position force exerted by the vessel positioning system to follow or substantially follow variations in the force exerted by the primary actuator. This is in particular done by limiting the integral gain of the controller.

In some embodiments, the pile guiding frame target position is a point on earth, and the excitation controller 80 of the guiding control unit controls the primary actuator 55 and/or secondary actuator 60 independently from the location of the floating vessel 24, or the position of the floating vessel 24 is measured with regard to a vessel target location on earth, and the excitation controller 80 of the guiding control unit controls the primary actuator 55 to cause the pile guiding frame 20 to make an opposite movement as the movement of the floating vessel 24 and/or the excitation controller 80 of the guiding control unit controls the secondary actuator 60 to cause the monopile to make an opposite movement as the movement of the floating vessel 24.

The resilience control unit may receive a lift force parameter representative of a lift force exerted by the crane on the pile, wherein the resilience control unit increases the resilience of the one or more primary actuators and/or the one or more secondary actuators when the lift force decreases.

During a significant portion of the lowering process, the guiding control unit is set to the active control mode in which the one or more primary actuators and the one or more secondary actuators are actively controlled. In the active control mode the guiding control unit maintains the pile guiding frame target position at a constant value and actively controls the primary and secondary actuators to move the pile guiding frame to the pile guiding frame target position.

At a certain point, the lift force becomes smaller because the weight of the pile is transferred to the seabed. The pile guiding system activates the inclination mode when the lift force drops below a predetermined inclination control threshold lift force, which may be a percentage of an initial lift force exerted by the crane on the pile before the pile touches the seabed. This inclination control threshold lift force can be relatively high, for instance as high as 90 percent of the initial lift force, or may be quite low, for instance 50 percent or even lower. The pile guiding system comprises a pile inclination input 71 for the input of an inclination angle θ of the pile relative to the vertical. In the inclination mode the guiding control unit 64 adjusts the pile guiding frame target position in dependence of the pile inclination input as explained in relation to FIGS. 9A and 9B. With the inclination mode it is possible to adjust for errors in displacements of the pile and restore the verticality of the pile.

The predetermined inclination control threshold lift force is lower than the active control threshold lift force.

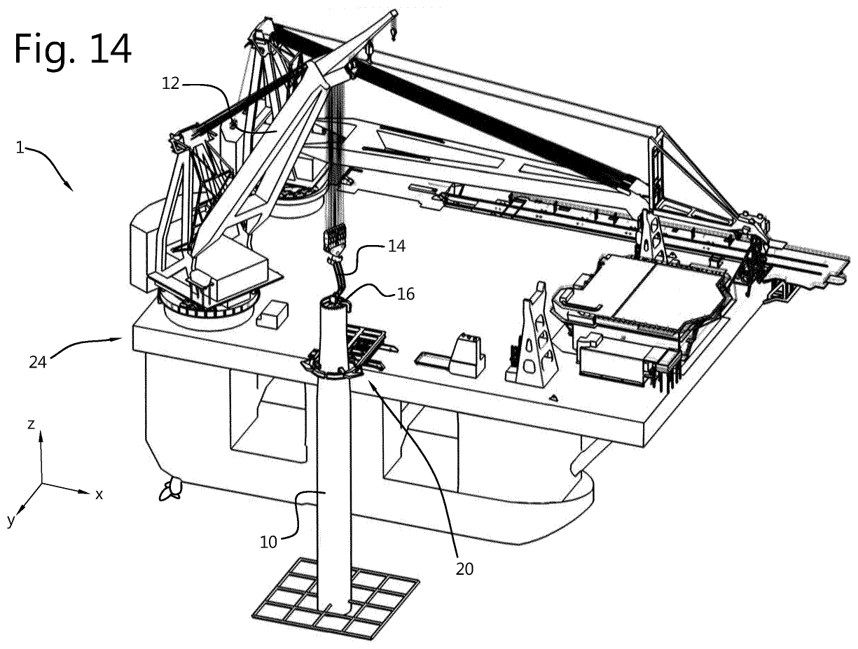

Turning to FIG. 14, at some point the full weight of the pile is carried by the seabed and the crane line 14 goes slack. The monopile 10 then needs to be hammered into the seabed further, but this is not part of the present invention.

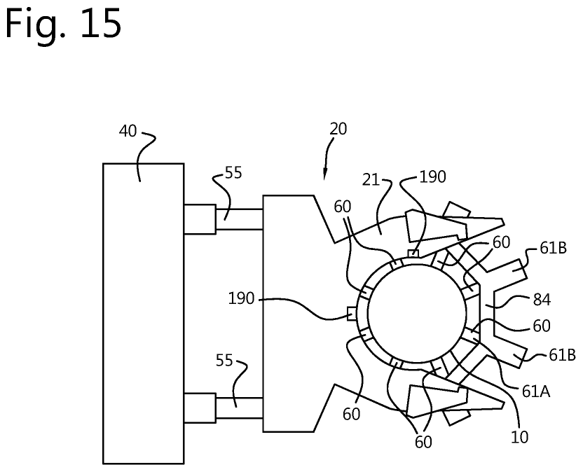

Turning to FIG. 15, another embodiment of the pile guiding frame 20 and the base 40 is shown. In this embodiment there are two primary actuators 55 and eight secondary actuators 60. It is noted that an outer part 61B of the secondary actuators may extend outward from the annular portion 21 of the pile guiding frame 20. but this is optional. The parts 61A of the one or more secondary actuators 60 that contact the pile 10 extend inward from the annular portion 21.

In another aspect, the present invention relates to an assembly for installing a pile at least partially into a seabed 28, the assembly comprising:
a floating vessel 24 comprising a vessel positioning system 42 for keeping the vessel at a vessel target location, wherein the vessel positioning system comprises:
   at least one vessel location sensor 43 for measuring the location of the floating vessel relative to the vessel target location,
   at least one thruster 47 and/or at least one anchor winch configured for exerting a vessel position force,
   a vessel position control unit 44 configured for controlling the vessel position force in dependence of the measured vessel location for maintaining the floating vessel at the vessel target location,
a pile guiding system 50 configured to guide the pile during the installation thereof, the pile guiding system comprising:
   a base 40 provided on the vessel,
   a pile guiding frame 20 connected to the base, the pile guiding frame being configured to accommodate and guide the pile during the installation thereof, wherein the pile guiding frame is configured to exert a force (F) on the pile, wherein the force has a horizontal component, p2 a guiding control unit 64 configured to send a feed forward signal 96 indicative of a force exerted by the pile guiding frame on the pile to the vessel position control unit of the vessel positioning system,
      wherein the vessel positioning system is configured to at least partially add the force to the vessel position force which is required for position keeping in order to maintain the floating vessel at the vessel target location while simultaneously exerting the force onto the pile.

The force may be measured by a force sensor of the pile guiding system or may be obtained indirectly, for instance from a known or measured hydraulic pressure in primary or secondary actuators 55, 60 of the pile guiding system 50. In some embodiments, the force may also be obtained directly from the guiding control unit.

In another aspect, the present invention relates to a pile guiding system 50 configured to guide a pile 10 during the lowering thereof by a crane 12 of a floating vessel 24, the pile guiding system comprising:
a base 40 configured to be connected to the vessel 24,
at least one pile guiding frame 30, the pile guiding frame connected to the base via at least one primary actuator 55, the pile guiding frame defining a through passage through which in use the pile extends, the annular pile guiding frame being configured to guide the pile during the lowering thereof, the pile guiding frame being configured to transfer a force (F) to the pile, wherein the force has a horizontal component,
one or more primary actuators 55 which are configured for moving the pile guiding frame relative to the base, wherein one or more primary actuators are configured for providing said force,
one or more secondary actuators 60 connected to the pile guiding frame and extending at least partially inward from the pile guiding frame, the one more secondary actuators being configured for maintaining the pile in a pile target position within the pile guiding frame,
at least one frame position sensor 62 for measuring an excitation parameter indicative of an excitation of the pile guiding frame relative to a pile guiding frame target position, and
a guiding control unit 64 configured to control the one or more primary actuators in dependence of the measured excitation of the pile guiding frame relative to the pile guiding frame target position to move the pile guiding frame to the pile guiding frame target position in case of an excitation of the pile guiding frame,
   wherein the guiding control unit comprises a resilience controller configured to control a resilience of the one or more primary actuators and/or the one or more secondary actuators during the lowering of the pile into the seabed in order to limit the force between the pile and the vessel.

In some embodiments. the pile guiding system comprises a pile inclination input 71 for input of an inclination angle of the pile relative to the vertical, wherein the control unit comprises an inclination mode, wherein in the inclination mode the guiding control unit is configured to adjust the pile guiding frame target position in dependence of the pile inclination input.

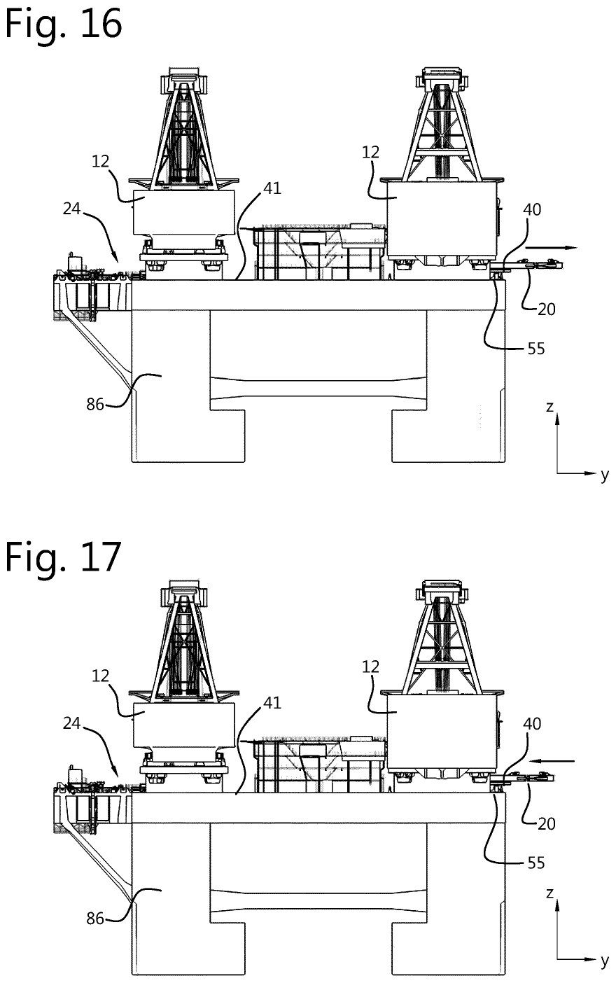

Turning to FIGS. 16 and 17 in a different invention, a method is provided for damping roll and/or pitch motions of a floating vessel, wherein the vessel comprises a pile guiding system, the pile guiding system comprising:
a base 40 provided on the vessel 24,
a pile guiding frame 20 connected to the base, the pile guiding frame being configured to accommodate and guide a pile during installation thereof,
at least one primary actuator 55 for moving the pile guiding frame relative to the base in a plane substantially parallel to a deck of the vessel,
   wherein the method comprises, when the pile guiding frame does not accommodate a pile, moving the pile guiding frame with the at least one primary actuator towards a centre of gravity of the vessel when the pile guiding frame moves downwards relative to the centre of gravity of the vessel caused by a roll motion and/or a pitch motion of the vessel, and/or moving the pile guiding frame away from the centre of gravity of the vessel when the pile guiding frame moves upwards relative to the centre of gravity of the vessel caused by of a roll motion and/or pitch motion of the vessel.

In some embodiments the pile guiding system comprises a first primary actuator 55A for moving the pile guiding frame in a first direction relative to the vessel, and a second primary frame actuator 55B for moving the pile guiding frame in a second direction relative to the vessel, the second direction being substantially perpendicular to the first direction.

In some embodiments the first primary actuator 55A and the second primary actuator 55B are configured to together move the pile guiding frame in all directions in the plane substantially parallel to the deck of the vessel.

In some embodiments the base and the pile guiding frame are provided at a location on the vessel between 40-60% of a length or a width of the vessel.

In some embodiments the base and the pile guiding frame are provided at a corner of the vessel.

In some embodiments the pile guiding frame—when seen in top view—extends beyond a contour of the vessel, i.e. outboard of a hull of the vessel.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

1.-71. (canceled)

72. An assembly for lowering a pile onto and partially into a seabed, the assembly comprising:
a floating vessel comprising a vessel positioning system, in particular a DP system, for maintaining the floating vessel at a vessel target location,
a crane provided on the vessel for lowering the pile onto and partially into the seabed, the crane comprising a lift member configured to be connected to the pile,
a pile guiding system configured to guide the pile during the lowering thereof by the crane, the pile guiding system comprising:
a base connected to the vessel,
at least one pile guiding frame comprising an annular portion, the pile guiding frame connected to the base via at least one primary actuator, the annular portion of the pile guiding frame defining a through passage through which in use the pile extends, the pile guiding frame being configured to guide the pile during the lowering thereof, the pile guiding frame being configured to transfer a force to the pile, wherein the force has a horizontal component,
one or more primary actuators which are configured for moving the pile guiding frame relative to the base, wherein the one or more primary actuators are configured for providing said force,
one or more secondary actuators connected to the annular portion of the pile guiding frame and extending at least partially inward from the annular portion, the one more secondary actuators being configured for maintaining the pile in a pile target position within the annular portion,
at least one frame position sensor for measuring an excitation parameter indicative of an excitation of the pile guiding frame relative to a pile guiding frame target position, and
a guiding control unit comprising an excitation controller configured to control the one or more primary actuators in dependence of the measured excitation of the pile guiding frame relative to the pile guiding frame target position in order to move the pile guiding frame to the pile guiding frame target position in case of an excitation of the pile guiding frame, and/or to control the one or more secondary actuators in dependence of the measured excitation of the pile guiding frame relative to the pile guiding frame target position in order to move the pile opposite to the movement of the pile guiding frame,
wherein the guiding control unit further comprises a resilience controller configured to control a stiffness of the one or more primary actuators and/or of the one or more secondary actuators during the lowering of the pile into the seabed in order to limit the force between the pile and the vessel which is transferred via the pile guiding frame.
